(19) United States
(12) Patent Application Publication
(10) Pub. No.: US 2011/0157304 A1
(43) Pub. Date: Jun. 30, 2011

(54) Three-dimensional television and motion picture method and apparatus

(76) Inventor: Sam Savoca, Geneva (CH)

(21) Appl. No.: 12/801,903

(22) Filed: Jun. 30, 2010

Related U.S. Application Data
(60) Provisional application No. 61/213,670, filed on Jul. 1, 2009.

(51) Int. Cl. H04N 13/04; H04N 13/00

(52) U.S. Cl. 348/43; 348/51; 348/E13.003; 348/E13.058

(57) ABSTRACT

Natural 3D images are created on a standard television screen or a movie screen which can be viewed without requiring the use of special glasses or viewing devices. For television, the incoming 2D signal and a delayed 2D signal are supplied simultaneously to the input of the television receiver to produce a 3D image on the screen. For motion pictures, the film and a staggered film portion separated by a predetermined number of frames are fed simultaneously and in opposite directions through a film gate of a projector and moved intermittently therein in a predetermined sequence to produce a 3D image on the motion picture screen.

### CROSS-REFERENCES TO RELATED APPLICATIONS

This application claims the priority of provisional Patent Application No. 61/213,670, filed on Jul. 1, 2009.

### BACKGROUND OF THE INVENTION

1. Field of the Invention

The present invention relates to a method and apparatus for three-dimensional (“3D”) viewing of television and motion pictures, and, more particularly, to such a method and apparatus that does not require the use of special glasses or viewing devices for 3D viewing.

2. Description of the Background Art

There are currently many different types of 3D viewing systems in use for television and motion pictures, all of which require the use of special glasses for 3D viewing. These systems are subject to one or more of the following disadvantages:

1. They do not show natural 3D and require special glasses, viewing devices or equipment;

2. There may be deleterious effects on the brain or the eyes by continuous long term viewing with special 3D glasses;

3. There may be a degradation of clarity, color or sound;

4. Significant changes are required to TV broadcasting systems;

5. 3D systems for television and motion pictures are complicated and expensive; and

6. The quality of the 3D viewing may vary depending on the viewing angles and distances from the TV or motion picture screen.

Accordingly, a need has arisen for a new and improved 3D viewing method and apparatus which does not require the use of special glasses or viewing devices for 3D viewing. The present invention meets this need.

### BRIEF SUMMARY OF THE INVENTION

The new and improved method and apparatus of the present invention produces natural 3D viewing of both television and motion pictures without the use of special glasses, viewing devices or expensive and complicated equipment.

For 3D television viewing, a first normal 2D television signal is sent to the television inlet in combination with a simultaneous second 2D signal that is delayed sufficiently from the first signal to produce 3D viewing on the television screen which does not require the use of special glasses. The delayed signal is obtained by the use of one or more capacitors wired in series to create the desired 3delay. For optimum 3D viewing, the delay should be about 1/10 of a second based on human brain capacity. The number of capacitors required to obtain the desired delay signal would depend on the frequency of the television set. If the delay between the first and second 2D signals is too large, flicker may occur which will adversely affect the 3D viewing. Also, if the delay is too short, there may be too small of a 3D effect.

For motion picture 3D viewing, the film from the film supply reel of a projector is passed through the film gate and thereafter a stagger loop is created which is then fed back into the film gate so that there is a delay of a predetermined number of frames before the film is fed back into the film gate in the opposite direction. In accordance with the normal operation of a projector, the overlapped films that are staggered by the predetermined number of frames are intermittently stopped in the film gate in a predetermined sequence to create a natural 3D projection on a motion picture screen. Normally a stagger of three or four film frames will produce natural 3D in a 24 frames per second projector. Preferably, the stagger should not be more than about eight film frames in order to preclude flicker which will adversely affect 3D viewing. Normal 2D film is used to produce the 3D effect in the projector. The film frame delay required for optimum 3D motion picture viewing will depend on the speed of the motion picture projector, and thus the size of the stagger loop can be varied depending on this speed.

### BRIEF DESCRIPTION OF THE DRAWINGS

FIG. 1 is a diagrammatic view of the apparatus in accordance with the present invention for producing 3D television viewing;

FIG. 2a is a diagrammatic view of a film projector during the first projection of an image for normal 2D motion picture viewing;

FIG. 2b is a diagrammatic view of the film projector of FIG. 2a when the light is blocked without film advance; and

FIG. 3 is a diagrammatic view of the new and approved apparatus of the present invention for producing 3D motion picture viewing.

### DETAILED DESCRIPTION OF THE INVENTION

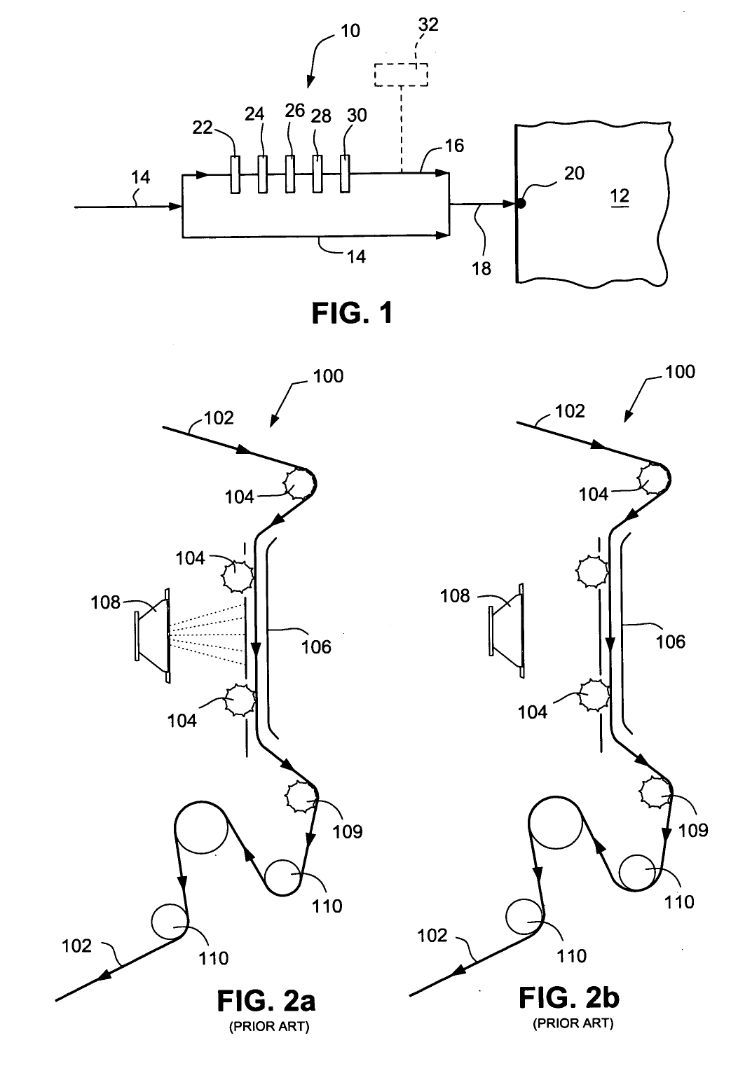

FIG. 1 illustrates the apparatus 10 for producing 3D images on the screen of a television receiver 12 without requiring the use of special glasses or viewing devices for 3D viewing. The apparatus 10 receives a first normal 2D TV signal 14 and produces a second delay 2D signal 16 that is combined with the first signal 14 and presented simultaneously as a 3D signal 18 to the antenna or signal inlet 20 of the television receiver 12. The delay signal 16 is produced, e.g., by passing the first 2D signal 14 through one or more capacitors 22, 24, 26, 28, 30 connected in series which create a delay between the second delay signal 16 and the first signal 14 that is sufficient to produce the 3D signal 18 that may be viewed as a 3D presentation on the television receiver 12 without the use of any special eyeglasses, viewing devices or the like. It has been found that optimum 3D viewing can be obtained with about one-tenth of a second delay between the first signal 14 and the second delay signal 16. If the delay is too long, flicker may occur which will adversely affect the TV viewing. On the other hand, if the delay is too short, there will be less of a 3D effect on the television screen.

The number and size of the capacitors 22-30 will depend on what is required to sufficiently delay the second delay signal 16 from the first signal 14 based on the frequency of the television receiver. As an illustrative example, in the case of a 50 hertz frequency television receiver, five capacitors 22-30 connected in series may be required with the following values:

| Capacitor | uF |
|---|---|
| 22 | 500 |
| 24 | 470 |
| 26 | 320 |
| 28 | 270 |
| 30 | 220 |

To adjust the capacitance, the capacitor 30 may be a variable capacitor. Also, as an option, a choke coil 32 shown in broken lines in FIG. 1 may be connected to the capacitors to adjust the delay. For television sets having a frequency higher than 50 hertz, more capacitors connected in series may be required to produce a sufficient delay for optimal 3D viewing.

It will be readily seen that the apparatus 10 for creating a 3D image on a television screen is simple in construction and may be easily connected to or built into a television receiver without requiring any significant changes to the normal television receiver construction. The new and improved apparatus 10 has the following advantages:
1. It produces natural 3D viewing;
2. No special glasses or equipment are required;
3. There is no degradation of clarity, color or sound;
4. The viewing of 3D can be effected from large angles with respect to the TV screen and various distances from the TV screen;
5. There are no deleterious effects by continuous long-term viewing.
6. No changes are required to TV broadcasting systems;
7. It works on large and small TV screens;
8. The apparatus is sufficiently compact to be easily mounted on or installed in a television receiver without any changes to the circuitry of the television receiver; and
9. The depth of the 3D viewing is clear, without degradation, either in front or behind the TV camera focal point.

FIG. 2a discloses one embodiment of a conventional motion picture projector 100 for producing a 2D image on a motion picture screen (not shown). The projector 100 generally comprises film 102 supplied from a supply reel (not shown) that is fed by sprockets 104 or the like through a film gate 106 and illuminated by a light source 108 during a first projection of the image for viewing on a motion picture screen (not shown). The film 102 leaving the film gate 106 is then fed over one or more sprockets 109 or pulleys 110 in a conventional manner to a film take up reel (not shown).

In accordance with normal projector operations, the light is blocked periodically without frame advance so that the film 102 advances intermittently through the film gate 106, as shown in FIG. 2b.

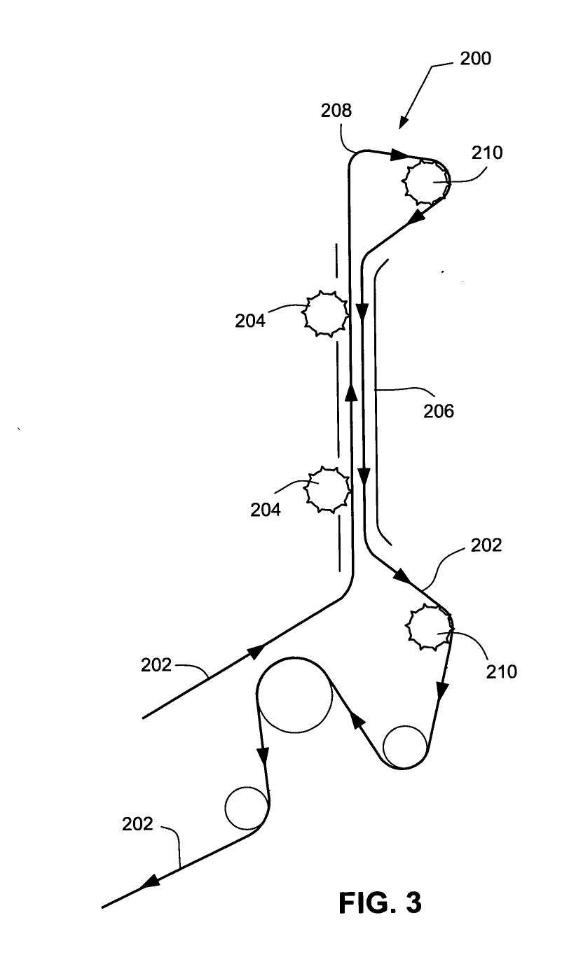

FIG. 3 illustrates one embodiment of a modified motion picture projector 200 for producing a 3D image on a motion picture screen without the use of special eyeglasses or viewing devices in accordance with the present invention. In the projector 200, sprockets 204 or the like advance the film 202 from a supply reel (not shown) upwardly through the film gate 206 and create a stagger loop 208 of a predetermined number of frames around a sprocket 110 or the like. The staggered film is then advanced by a sprocket 210 or the like in the opposite direction through the film gate 206. Because of the intermittent advancement of the staggered film layers through the film gate 206 in a predetermined sequence, a 3D image is produced on the motion picture screen (not shown) as a result of the frame delay between the two levels of film in the film gate 206.

The film 202 leaving the film gate 206 is then moved over a series of sprockets and/or pulleys to a take-up reel (not shown) in a conventional or any suitable manner.

For a twenty four frames per second motion picture projector, the delay produced by the stagger loop 208 should be at least four frames before entering the film gate 206 in the opposite direction for the purpose of creating an optimum 3D presentation on the motion picture screen. Preferably, the delay should not exceed eight film frames in order to preclude flicker which will adversely affect viewing.

It will be noted that the modified projector 200 for 3D motion picture viewing is simple in construction and requires minimal changes to a standard motion picture projector to produce the desired 3D motion picture viewing without requiring any special glasses or other viewing devices. The projector 200 has the following advantages:
1. It can be easily adjusted to show natural 3D viewing;
2 Only one projector is required;
3. Only one 2D film is required to show 2D or 3D images;
4. It is fairly simple to change from 2D to 3D showing or vice versa;
5. No glasses or special viewing equipment is required to see 3D;
6. No changes are required to the theatre screen to show either 2D or 3D;
7. There are no deleterious effects by continued long term viewing;
8. There is no degradation of clarity, color or sound; and
9. Optimum 3D viewing on the motion picture screen is available from all seating in a theatre or the like.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of producing a natural 3D image on a television screen, comprising:
supplying an input signal to a television receiver, said input signal comprising a first 2D input signal combined with a second 2D input signal that is delayed a predetermined amount of time from said first signal to create a 3D image on the television screen that can be viewed without the use of special glasses or viewing devices.

2. The method of claim 1 wherein said second 2D input signal is delayed from said first 2D input signal by a time period sufficient to produce a clear 3D image that can be processed by a human brain.

3. The method of claim 2 wherein said time period is approximately one-tenth of a second or less.

4. The method of claim 1 wherein the delay of said second 2D input signal is produced by one or more capacitors.

5. The method of claim 4 wherein a plurality of capacitors are used that are wired in series.

6. The method of claim 5 wherein one of said capacitors is a variable capacitor.

7. The method of claim 5 wherein a choke coil is connected to said capacitors to enable the delay time period to be adjusted.

8. The method of claim 4 wherein the number of capacitors required to produce the delay time period is determined by the frequency of the television receiver.

9. A method of producing a natural 3D image on a motion picture screen with the use of a projector having film with a plurality of frames that is moved intermittently through a film gate to project an image on the screen, comprising:
moving the film through the film gate in a first direction, creating a staggered portion of a predetermined number of frames in the film after it leaves the film gate, and
moving the staggered film back into the film gate in a second direction opposite to the first direction so that the layers of the film therein are staggered by the predetermined number of frames and intermittently advanced in a predetermined sequence to produce the 3D image on the screen which can be viewed without the use of special glasses or viewing devices.

10. The method of claim 9 wherein the staggered portion of the film is created by forming a stagger loop in the film after it leaves the film gate.

11. The method of claim 9 wherein the predetermined number of frames is sufficient to produce a clear 3D image on the screen that can be processed by a human brain.

12. The method of claim 11 wherein the predetermined number of frames is approximately eight or less for a projector operating at twenty-four frames per second.

13. The method of claim 12 wherein the predetermined number of frames is at least four frames.
